(19) United States
(12) Patent Application Publication
(10) Pub. No.: US 2015/0034427 A1
(43) Pub. Date: Feb. 5, 2015

(54) BRAKE VIBRATION ISOLATOR FOR BICYCLE FRAME

(71) Applicant: Specialized Bicycle Components, Inc., Morgan Hill, CA (US)

(72) Inventors: Sam Pickman, Morgan Hill, CA (US); Paul Mayes, Sammamish, WA (US); John Gershenson, Chassell, MI (US)

(21) Appl. No.: 14/444,442

(22) Filed: Jul. 28, 2014

Related U.S. Application Data
(60) Provisional application No. 61/958,647, filed on Aug. 2, 2013.

(51) Int. Cl. F16D 65/00; F16F 7/104; B62L 1/00

(52) U.S. Cl. CPC F16D 65/0006; B62L 1/00; F16F 7/104
USPC 188/26

(57) ABSTRACT

Tuned mass dampers are disclosed, and that are configured to cancel vibrations of a component of a bicycle at a natural frequency of the component in response to operation of a disc brake assembly of the bicycle. For instance, the component may comprise one or more frame members (e.g., the entire bicycle frame) of the bicycle and the damper may be engaged therewith and configured for cancellation/dampening of vibrations at the natural frequency of the bicycle frame as measured at the frame member to which the damper is attached. Accordingly, when a driving force is imparted to the frame member by operation of a disc brake assembly at a frequency at or near the natural frequency of the bicycle frame, the damper may counteract such vibration.

### CROSS-REFERENCE TO RELATED APPLICATIONS

This patent application is a non-provisional patent application of, and claims priority to, pending U.S. Provisional Patent Application Ser. No. 61/958,647, that is entitled “BRAKE VIBRATION ISOLATOR FOR BICYCLE FRAME,” that was filed on Aug. 2, 2013, and the entire disclosure of which is hereby incorporated by reference in its entirety herein.

### BACKGROUND

Recently, the use of disc brakes on bicycles has been gaining in popularity. While the use of disc brakes on bicycles is most common on mountain bicycles, other types of bicycles such as road bicycles, touring bicycles, hybrid bicycles, or others may utilize disc brakes. Disc brake assemblies generally include a caliper mounted to the bicycle frame and a disc (sometimes referred to as a rotor) mounted for co-rotational movement with a wheel of the bicycle. In this regard, the caliper may be actuated to squeeze the rotating disc between a pair of brake pads. The clamping action of the caliper relative to the disc results in the brake pads frictionally engaging the disc, thus converting kinetic energy into heat and braking the wheel.

Disc brakes may provide advantages over other types of bicycle braking systems. For example, disc brakes tend to perform well in a multitude of conditions, including wet and/or muddy conditions. Disc brakes may also be less susceptible to brake fade. Furthermore, as the wear components of a disc brake assembly (e.g., the rotor and the brake pads) may be easily and relatively inexpensively replaceable, disc brakes may provide advantages to brake systems that use frictional engagement of the wheel rim or the like. In this regard, disc brakes have become increasingly common on many types of bicycles.

However, despite the advantages provided by disc brakes, a well known problem with the use of disc brakes on bicycles are vibrations caused by the operation of the disc brakes. Specifically, when the disc brake is operated such that the brake pads frictionally engage the disc, the contact between the spinning disc and the brake pads may undergo slip-stick friction, whereby the brake pads may experience changes in the amount of braking force applied by the brake assembly. The slip-stick action between the brake pads and the spinning disc is caused by very high friction coefficients of the brake pad materials. This high friction causes them to start sticking at relatively high velocities. In any regard, the slip-stick friction may result in a driving force acting on the surrounding components including, for example, the caliper and the frame member to which the caliper is engaged.

### SUMMARY

In view of the foregoing, it has been recognized that in some cases, the driving force frequency from operation of a bicycle disc brake matches the natural frequency of the surrounding components, such as the bicycle frame, resulting in a vibration that can cause discomfort, a drop in bicycle performance, and an accelerated fatigue of components adjacent to the disc brake assembly. Vibration resulting from the driving force acting on a bicycle in response to the operation of a disc brake (e.g., a disc brake experiencing slip-stick friction) may be addressed by way of the use of one or more dampers that are tuned to a desired frequency. Specifically, it has been recognized that the operation of a disc brake may result in a driving force being imparted to one or more adjacent frame members that cause the bicycle frame to resonate at the natural frequency of the bicycle frame. That is, the frequency of the driving force may match or nearly match the natural frequency of the bicycle frame, such that one or more components that are excited by the driving force may resonate. The result of the resonance of the one or more components may be enhanced vibration, noise, a drop in performance of the bicycle, and/or accelerated fatigue of bicycle components, among other undesirable effects.

Accordingly, the present disclosure generally relates to the use of a damper that is configured to dampen vibrations of a component at a natural frequency of the component such that resonance in the component resulting from operation of a disc brake assembly may be at least reduced and the amplitude of the vibrations experienced by the component at or near the natural frequency of the component may be at least reduced. As such, the disadvantageous conditions noted above that have been experienced in the use of disc brake assemblies on bicycles may be at least partially reduced. Specifically, the present disclosure includes the use of a tuned mass damper that is configured to cancel or dampen vibrations at a natural frequency of the component to which the damper is engaged to reduce the potential of resonance of the component in response to the operation of a disc brake assembly. In this regard, the tuned mass damper may include a mass isolated in at least some respect from the member to be dampened by one or more resilient members. In turn, the size of the mass and/or the properties (e.g., effective spring constant, energy dissipation properties, thickness, etc.) of the resilient member(s) may be specifically selected to target the frequency of vibration to be dampened (i.e., the natural frequency of the component to which the damper is engaged). In this regard, the mass of the damper may move relative to the component to be dampened in a manner that is out of phase with the vibration of the component, thus damping the vibration in the component.

Accordingly, a first aspect of the present invention is embodied by a bicycle. The bicycle includes a bicycle frame, a disc brake assembly, and at least one damper. The bicycle frame includes at least one frame member. The bicycle frame is operatively engaged with at least one wheel (e.g., each wheel may be rotatably supported by the bicycle frame). The disc brake assembly is operatively engaged with the bicycle frame (e.g., mounted to the frame) and is associated with a corresponding wheel of the bicycle. When braking the wheel, the disc brake assembly may impart a driving force to the bicycle frame at a natural frequency of the bicycle frame (e.g., operation of the disc brake assembly may excite the bicycle frame at a natural frequency of the bicycle frame). The damper is operatively engaged with the frame member and is configured to dampen vibration in the bicycle frame at the natural frequency of the bicycle frame (e.g., as measured at the frame member; the natural frequency of the bicycle frame that is excited by operation of the disc brake assembly) in response to the vibration imparted by the disc brake assembly at the natural frequency of the bicycle frame when braking the wheel.

A number of feature refinements and additional features are applicable to the first aspect. These feature refinements and additional features may be used individually or in any combination. As such, each of the following features that will be discussed may be, but are not required to be, used with any other feature or combination of features of the first aspect.

For instance and in an embodiment, the frame member may be a seat stay and/or a chain stay. In other embodiments, the damper may be configured for engagement with any other frame member of the bicycle frame and/or with other components of the bicycle. In any regard, the damper may be configured to dampen at least one natural frequency of the component, a given frame member, or the entire bicycle frame to which it is attached. The damper and the disc brake assembly may be mounted to or otherwise incorporated by the frame member (including where the frame member is the seat stay, and further including where the damper is mounted at least generally midway along a length dimension of the seat stay).

In an embodiment, the damper includes a resilient member and a mass. The mass may be supportably engaged by the resilient member in at least some respect such that the mass is deflectable relative to the frame member by way of deflection of the resilient member (e.g., in at least one dimension). In this regard, the resilient member and/or the mass are configured (e.g., provided or selected) so that the mass is deflectable relative to the resilient member in a manner that is out of phase with respect to vibrations of the bicycle frame (e.g., the frame member to which the damper is attached) when the bicycle frame vibrates at a natural frequency of the bicycle frame in response to an imparted driving force resulting from braking the wheel with the disc brake assembly. One embodiment has the damper being configured or tuned so as to dampen at least 90% of the amplitude of the vibration in the bicycle frame, where this vibration is at the natural frequency of the bicycle frame that is excited by operation of the disc brake assembly. One embodiment has the damper being tuned to a frequency that is within about 50 Hz of the natural frequency of the bicycle frame that is excited by operation of the disc brake assembly (e.g., the damper is configured to dampen vibrations at a frequency that is within about 50 Hz of the natural frequency of the bicycle frame that is excited by operation of the disc brake assembly).

In an embodiment, at least part of the damper may be integrally provided with the frame member (e.g., a damper body). In another embodiment, the damper may include a separately formed damper body with a frame engagement portion and a mass engagement portion. The frame engagement portion may be rigidly engageable with the frame member, that in turn supportably engages a disc brake assembly that is operable to brake the wheel. In any case and when the frame engagement portion is appropriately engaged with the bicycle frame, the frame engagement portion may vibrate concurrently with the frame member (to which the damper body is attached or mounted). The resilient member and mass each may be supported by the mass engagement portion of the damper body in at least some respect, and the mass engagement portion may be interconnected with the frame engagement portion in any appropriate manner (e.g., the mass engagement portion and frame engagement portion may simply be different parts of a common, unitary damper body, or the mass engagement portion and frame engagement portion could be separate parts that are appropriately fixed relative to one another).

In an embodiment, the frame engagement portion may include a clamping assembly that is clampingly engaged with the frame member of the bicycle frame. Alternatively, the frame engagement portion may attachably engage a frame member of the bicycle frame in any other appropriate manner including, for example, use of other fasteners (e.g., zip ties), an adhesive, welding, or some other attachment mechanism. In an embodiment, the frame engagement portion may include an at least partially conformably contoured surface to at least partially conformably contact the frame member.

In an embodiment, the resilient member may be disposed on at least a first side of the mass to allow the mass to be deflectable in at least one dimension relative to the damper body. In another embodiment, resilient members may be provided on at least two opposing sides or ends of the mass and the mass engagement portion to allow the mass to deflect in at least one dimension relative to the damper body (including where motion of the mass is constrained to within a single dimension or along a single axis, and further including where a pair of resilient members are spaced along this axis and engaged with opposing ends of the mass). In another embodiment, a resilient member may be disposed on at least a third side of the mass between the mass and the mass engagement portion (e.g., to facilitate/accommodate deflection or movement of the mass in more than one dimension). For instance, the resilient member may be only in contact with three sides of the mass between the mass and the mass engagement portion. In any regard, the at least one dimension in which the mass is deflectable may correspond to a dimension of an amplitude of vibration of the bicycle frame (e.g., one or more of the frame members) in response to the imparted driving force resulting from braking the wheel with the disc brake assembly. Thus, the mass may be controllably deflectable to cancel or dampen vibrations at a predetermined frequency, such as the natural frequency of the bicycle frame that is excited by operation of the disc brake assembly. It should be appreciated that a single resilient member could interface with one or more sides of the mass, that separate resilient members could be utilized to engage at least two different sides of the mass, or both.

The mass may be characterized as being disposed within an enclosure defined at least by the mass engagement portion. In turn, the resilient member may be disposed between at least a portion of the mass and a wall or sidewall of the enclosure. The enclosure may substantially enclose the entirety of the mass in at least one dimension (e.g., it may extend about the entirety of a perimeter of the mass in at least one dimension).

In an embodiment, the mass may be slidably disposed relative to a bushing provided in an enclosure. Accordingly, the resilient member may be disposed relative to the mass to allow deflection of the mass along a direction of sliding engagement with the bushing. For instance, the mass may comprise a cylindrical mass and the bushing may be a tubular bushing in which the cylindrical mass may be slidably disposed. In turn, the resilient member may be disposed in the tubular bushing on at least one side of the cylindrical mass. Other shapes may be appropriate, where the mass is disposed within a hollow interior of a bushing (e.g., for at least somewhat controlled motion of the mass relative to the damper body). In any case, the bushing may constrain movement of the mass to along a single axis.

The mass and at least one resilient member may be disposed (e.g., removably) within a receptacle of a damper body, including where the mass and resilient member(s) are enclosed within such a receptacle (e.g., by utilizing a movable/removable cap, cover, door, or the like in conjunction with a damper body). The mass may be disposed between first and second resilient members, for instance where the first resilient member is disposed within the receptacle and engages a first end of the mass, where the second resilient member is also disposed within the receptacle and engages a second end of the mass, and where this first and second ends of the mass are opposite of each other. The first and second resilient members may be characterized as being spaced along an axis which the mass moves during vibration of the bicycle frame. The damper may be configured to limit motion of the mass relative to the damper body to being along this axis. Although the above-noted bushing could be disposed between an inner wall of the receptacle and each of the mass, the first resilient member, and the second resilient member, one embodiment excludes such a bushing. For instance, the mass could either be in contact with or separated from the inner wall of the receptacle by an open space that extends from the mass to the inner wall of the receptacle.

In an embodiment, the enclosure may include a cap, cover, or door selectively displaceable relative to the enclosure (or more generally the damper body) to provide access to the mass and/or resilient member. For example, the door may comprise a hinged door, an end cap, or the like. Upon removal or disengagement of the door relative to the damper body, the mass and/or resilient member may be removable from the mass engagement portion of the damper body. As such, the mass and/or resilient member may be replaceable. In turn, the damper may be provided as a kit with the damper body and one or more masses and one or more resilient members. In turn, different mass and/or resilient member combinations may be provided so that the damper may be reconfigurable to target more than one frequency for cancellation or dampening (e.g., depending upon the component or frame member to which the damper is to be attached).

In an embodiment, the frequency of the driving force imparted to the bicycle frame from the operation of the disc brake assembly (e.g., to brake the wheel) and the natural frequency of the bicycle frame measured at the frame member may be at least about 200 Hz and not more than about 320 Hz (e.g., the natural frequency of the bicycle frame that is excited by operation of the disc brake assembly may range from about 200 Hz to about 320 Hz). In another embodiment, the frequency of the driving force imparted to the bicycle frame from operation of the disc brake assembly (e.g., to brake the wheel) and the natural frequency of the bicycle frame measured at the frame member may be about 260 Hz. In still another embodiment, the frequency of the driving force imparted to the bicycle frame from operation of the disc brake assembly (e.g., to brake the wheel) and the natural frequency of the bicycle frame measured at the frame member may be about 240 Hz. In each such case, the damper may be configured to dampen a substantial portion of a vibration at such a natural frequency of the bicycle frame that is excited by operation of the disc brake assembly.

A second aspect of the present invention is embodied by a method for damping vibrations in a bicycle frame. The method may include braking a wheel of the bicycle with a disc brake assembly. The disc brake assembly may be mounted to and/or interconnected with the bicycle frame. The method may also include imparting a driving force to the bicycle frame at a natural frequency of the bicycle frame in response to the braking of the wheel—stated another way, operation of the disc brake assembly may excite a vibration in the bicycle frame at a natural frequency of the bicycle frame. Furthermore, the method may include damping vibration of the bicycle frame with a damper operatively engaged with the frame member, where the damper is configured to cancel or dampen vibration resulting in the bicycle frame at the natural frequency of the bicycle frame (e.g., as measured at the frame member) in response to receipt of the driving force at the bicycle frame.

A third aspect of the present invention is embodied by a damper for damping vibration in a bicycle frame. The damper may include a damper body with a frame engagement portion, a resilient member, and a mass. The frame engagement portion may be engaged (e.g., rigidly) with at least one frame member of a bicycle frame, where the frame supportably engages a disc brake assembly, where the disc brake assembly is operable to brake a wheel, and where the wheel is rotatably supported by the bicycle frame and is associated with the disc brake assembly. Accordingly, when the frame engagement portion is appropriately engaged with the bicycle frame, the frame engagement portion vibrates concurrently with the frame member to which it is attached. The resilient member is operatively engaged with a mass engagement portion of the damper body and the mass is supportably engaged by the resilient member relative to the mass engagement portion. Accordingly, the mass is deflectable relative to damper body by way of deflection of the resilient member. The resilient member and the mass are configured so that the mass is deflectable relative to damper body out of phase with respect to vibrations of the frame member when the frame member vibrates at a natural frequency of the bicycle frame (e.g., measured at the frame member) in response to an imparted driving force resulting from braking the wheel with the disc brake assembly. As such, the amplitude of vibration of the bicycle frame at the natural frequency is desirably reduced.

A number of feature refinements and additional features are applicable to the second and/or third aspect. For example, any of the foregoing feature refinements and/or additional features described in relation to the first aspect may be used with the second and/or third aspects. These feature refinements and additional features may be used individually or in any combination. As such, each of the foregoing features discussed in relation to the first aspect may be, but are not required to be, used with any other feature or combination of features of the second or third aspect.

### BRIEF DESCRIPTION OF THE DRAWINGS

FIG. 1 depicts a side view of an embodiment of a bicycle showing potential locations for placement of an embodiment of a damper to dampen vibrations induced by operation of a disc brake assembly.

FIG. 2A depicts an enlarged, perspective view of an embodiment of a disc brake assembly on a bicycle.

FIG. 2B depicts a schematic end view of an embodiment of a disc brake assembly in relation to a bicycle wheel.

FIG. 3 depicts a perspective view of an embodiment of a damper for a bicycle frame.

FIG. 4 depicts a side view, partly in phantom, of another embodiment of a damper operatively engaged with a chain stay of a bicycle.

FIG. 5 depicts a cross-sectional view, partly in phantom, of the damper shown in FIG. 4, taken along line 5-5 in FIG. 4.

FIG. 6 depicts a top view, partly in phantom, of the damper shown in FIG. 4.

FIG. 7A depicts a cross-sectional view of the damper of FIG. 4, taken along line 7-7 in FIG. 4.

FIG. 7B depicts a cross-sectional view of a variation of the damper of FIG. 4.

FIG. 8 depicts a perspective view of the damper of FIG. 4.

FIG. 9 depicts comparative plots of vibrations in a frame member during operation of a disc brake assembly without the use of a damper and with the use of a damper that is tuned to the natural frequency of the bicycle frame.

### DETAILED DESCRIPTION

The following detailed description should be read with reference to the drawings, in which like elements in different drawings are numbered identically. The following description is not intended to limit the invention to the forms disclosed herein. Consequently, variations and modifications commensurate with the following teachings, skill and knowledge of the relevant art, are within the scope of the present invention. The embodiments described herein are further intended to explain modes known of practicing the invention and to enable others skilled in the art to utilize the invention in such, or other embodiments and with various modifications required by the particular applications(s) or use(s) of the present invention.

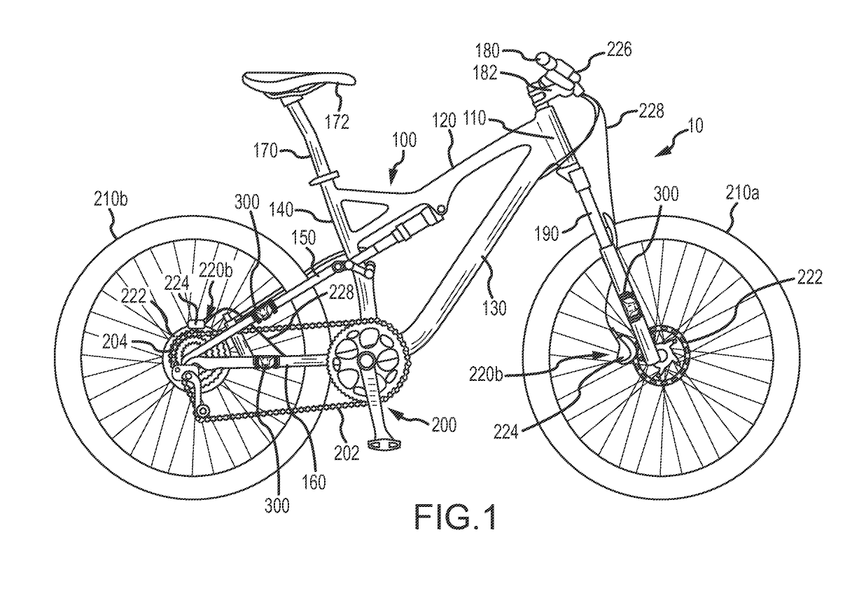

The present disclosure is generally directed to dampers for use with bicycles employing disc brakes. Specifically, the embodiments of dampers disclosed herein may be used to dampen vibrations of a component of the bicycle (e.g., a frame member, a portion of the disc brake assembly, the entire bicycle frame, etc.) resulting from a driving force acting on the component when the disc brake is actuated to brake a wheel of the bicycle. In this regard, vibrations, and in particular vibrations at the natural frequency of the component, may be dampened by a damper affixed to the component of the bicycle, where these vibrations are induced by operation of a disc brake assembly for the bicycle. In this regard, the present application is generally related to human-powered pedal bicycles (a representative embodiment being depicted in FIG. 1). As may be appreciated by those skilled in the art, weight considerations may be crucial to the performance of human-powered bicycles. Accordingly, the dampers disclosed herein may be particularly suited for use with bicycles, as the components used by these dampers may only insignificantly contribute to the overall weight of the bicycle while still providing a desired damping action of the component to which they are attached. For example, the overall weight of the dampers addressed herein may be less than about 40g in one embodiment, and within a range of about 30g to about 40g in another embodiment.

With reference to FIG. 1, a human-powered pedal bicycle 10 is shown that may include one or more dampers 300 at various locations for damping vibrations of the bicycle 10 resulting from operation of one or more disc brake assemblies of the bicycle 10. It will be appreciated that while a plurality of dampers 300 are shown in FIG. 1, it may be that a single one or less than all of the plurality of dampers 300 shown may be utilized by the bicycle 10. The dampers 300 shown in FIG. 1 are for illustrative purposes in relation to potential damper locations on the bicycle 10. One or more dampers 300 may be used by the bicycle 10, and may be disposed at any appropriate location. Notably, at least one of these dampers 300 (thereby encompassing all dampers 300) may be tuned to a natural frequency of a frame 100 for the bicycle 10 that may be excited by operation of one or more disc brake assemblies of the bicycle 10.

The bicycle frame 100 may include a head tube 110, a top tube 120, a down tube 130, a seat tube 140, a pair of seat stays 150, and a pair of chain stays 160. A seat post 170 may be engaged with the seat tube 140 to supportably engage a seat 172. The head tube 110 may engage a fork 190 that is in turn attached to handlebars 180 by way of a stem 182.

The bicycle 10 may further include a front wheel 210a and a rear wheel 210b (the rear wheel 210b being disposed between the pair of seat stays 150 and the pair of chain stays 160). The front wheel 210a may be rotatably supported by the fork 190, while the rear wheel 210b may be rotatably supported between two rear dropouts defined by corresponding ones of a chain stay 160 and seat stay 150 on opposite sides of the rear wheel 210b. The bicycle 10 may also include a crank set 200 disposed at a bottom bracket of the bicycle frame 100 at or near the intersection of the down tube 130 and the seat tube 140. A chain 202 is operatively engaged with the crank set 200 and a rear cassette 204. In this regard, rotation of the crank set 200 by a rider of the bicycle 10 (e.g., by pedaling), rotates or advances the chain 202, which in turn rotates the cassette 204, and which in turn rotates the rear wheel 210b to provide motive force to the bicycle 10.

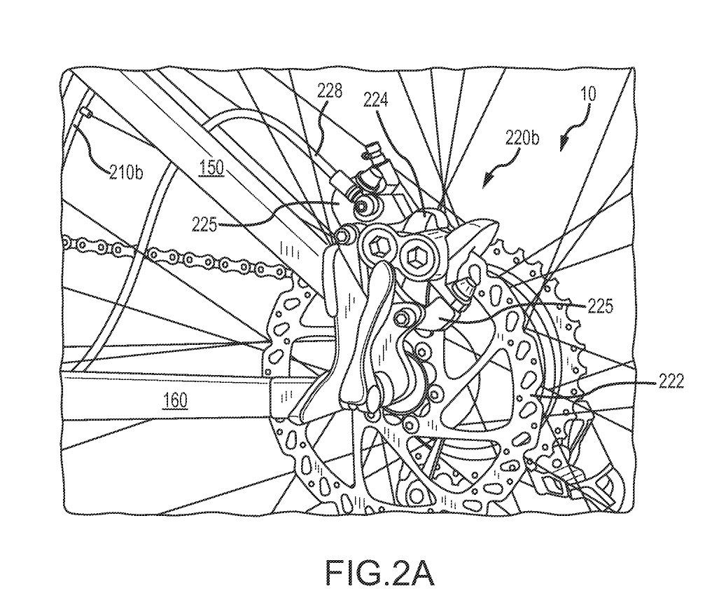

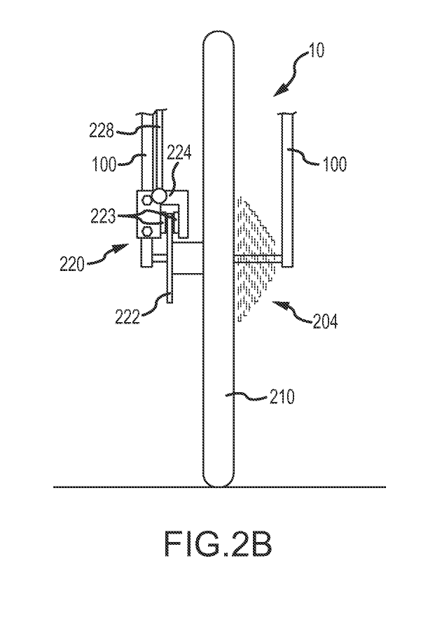

The wheels 210a, 210b may be engaged with the bicycle frame 100 such that the wheels 210a, 210b rotate relative to the bicycle frame 100. Additionally, the bicycle 10 may include disc brake assemblies 220a, 220b for the front and rear wheels 210a, 210b, respectively. With regard to the disc brake assembly 220a for the front wheel 210a, its caliper 224 may be affixed to the fork 190. A more detailed view of the rear disc brake assembly 220b, that is mounted adjacent to the rear wheel 210b, is shown in FIG. 2A. In the case of the rear wheel 210b, the caliper 224 for the disc brake assembly 220b may be affixed to the chain stay 160 or the seat stay 150 (as shown in FIGS. 1 and 2A, discussed below) depending upon the application. In any regard, the caliper 224 may be actuated by way of a brake lever 226 disposed on the handlebars 180. A given caliper 224 may be connected to its corresponding brake lever 226 by way of an actuation cable 228.

A representative schematic of a disk brake assembly that may be used by the bicycle 10 of FIG. 1 is illustrated in FIG. 2B and is identified by reference numeral 220. The disc brake assembly 220 includes a disc 222 that is operatively engaged with the wheel 210 (either the front wheel 210a or the rear wheel 210b). The disc 222 may be attached to or interconnected with the wheel 210 in any appropriate manner such that the disc 222 rotates along with the wheel 210 during operation of the bicycle 10. In addition and as noted, the disc brake assembly 220 may include a caliper 224. The caliper 224 may be supportably engaged with the bicycle frame 100. FIG. 2B also shows the above-noted rear cassette 204 in phantom, which may be provided in engagement with the wheel 210 for the case where the brake assembly 220 in FIG. 2B is for the rear wheel 210b.

The disc brake assembly 220 may be a mechanical or hydraulic disc brake system. In the case of a mechanical disc brake system for the bicycle 10, the actuation cable 228 between the brake lever 226 and the caliper 224 may include a pull wire or the like. Accordingly, upon actuation of the brake lever 256, a pull wire of the actuation cable 228 may mechanically act on the caliper 224 to actuate the caliper 224. In the case of hydraulic disc brake system, a fluid may be provided within the actuation cable 228 (which may be tubular, or more generally in the form of a conduit) such that fluid pressure imparted by the brake lever 226 on the fluid within the actuation cable 228 may act with hydraulic pressure upon the caliper 224 to actuate the caliper 224. In either style of disc brake system, upon actuation of the caliper 224, the caliper 224 may act to move one or more brake pads 223 (e.g., a pair of spaced brake pads 223—one on each side of the disc 222) into frictional engagement against the disc 222 associated with the wheel 210. In this regard, squeezing the disc 222 with the brake pad(s) 223 results in friction, which acts to brake the wheel 210.

As noted above and in the case of the rear wheel 210b, the rear disc brake assembly 220b may be mounted to the seat stay 150 or the chain stay 160. In this regard, it may be appreciated that the frame member to which a given disc brake assembly 220 is attached may include attachment posts 225. In this regard, the caliper 224 may be mounted to the attachment posts 225 such that the caliper 224 is positioned relative to the disc 222 as shown in FIGS. 2A and 2B. As such, it may be appreciated that the caliper 224 may be characterized as being rigidly attached to the bicycle frame 100 such that any force acting on the caliper 224 during operation of the disc brake assembly 220 may be transmitted to the frame member to which it is attached. Accordingly and as described above, a driving force acting on the caliper 224 upon actuation of the disc brake assembly 220 may result in a driving force being imparted to the bicycle frame 100 to which the caliper 224 may be attached. Any appropriate way of integrating the calipers 224 with the bicycle frame 100 may be utilized, including where vibrations induced from operation of the disk brake assembly 220 are transmitted to the bicycle frame 100.

The noted driving force may be imparted to the seat stay 150 and/or the chain stay 160 in the case of a rear brake assembly 220b. In the case of the front disc brake assembly 220a, a driving force may be imparted to the fork 190. Furthermore, vibrations may be transmitted through the bicycle frame 100 to other frame members. It may further be appreciated, given the relatively large range of potential operating speeds of the wheels 210a, 210b during operation of the bicycle 10 and/or variations in the slip-stick friction acting between the brake pads 223 and corresponding disc 222, upon actuation of the caliper 224 to engage the disc 222, a wide range of frequencies of the driving force may be imparted onto the frame members, including specifically the seat stay 150 and/or chain stay 160. In this regard, at least in certain operating conditions, the frequency of the driving force acting on the bicycle frame 100 may result in the bicycle frame 100 (e.g., including one or more of the individual frame members) being excited at the natural frequency of the bicycle frame 100 and/or the natural frequency of the individual frame member. As described above, this may cause the bicycle frame 100 to resonate, which may lead to large amplitude vibration that results in harsh vibration experienced by the rider of the bicycle 10, noise, a drop in performance of the bicycle 10, and/or premature fatigue of the bicycle frame 100.

In this regard and as shown in FIG. 1, a frame member of the bicycle frame 100 (e.g., the seat stay 150, chain stay 160, fork 190, or other frame member) may have a damper 300 operatively engaged therewith—one or more dampers 300 may be mounted to or otherwise incorporated by the bicycle frame 100. In this regard, the damper 300 may be configured to dampen vibrations at the natural frequency of the bicycle frame 100 (e.g., as measured at the frame member to which it is attached) that is excited by operation of the disc brake assembly 220a and/or disc brake assembly 220b. In this regard, it may be appreciated that the damper 300 may be configured specifically for the frame member to which it is attached to cancel vibrations at the natural frequency of the bicycle frame 100 and as measured at the frame member. That is, the chain stay 160 may vibrate at a different frequency during resonance of the bicycle frame 100 (from operation of the disc brake assembly 220a and/or disc brake assembly 220b) than does the seat stay 150. Accordingly, a damper 300 engaged with the chain stay 160 may be configured to dampen frequencies at or near the natural frequency of the bicycle frame 100 as measured at the chain stay 160, and a damper 300 engaged with the seat stay 150 may be configured to dampen frequencies at or near the natural frequency of the bicycle frame 100 as measured at the seat stay 150. The configuration of the damper 300 may include selection of or configuration of a damper 300 with an appropriately sized mass and/or a resilient member with appropriate properties as may be appreciated and as addressed below with respect to the discussion of the configuration of the damper 300. That is, each damper 300 used by the bicycle 10 may be characterized as being tuned to dampen vibrations at the natural frequency of the bicycle frame 100 that is excited by operation of the disc brake assembly 220a and/or disc brake assembly 220b.

One embodiment has one or more dampers 300 that are configured or tuned so as to dampen at least 90% of the amplitude of a vibration in the bicycle frame 100, where this vibration is at a natural frequency of the bicycle frame 100 that is excited by operation of the disc brake assembly 220a and/or disc brake assembly 220b. One embodiment has one or more dampers 300 being tuned to a frequency that is within about 50 Hz of a natural frequency of the bicycle frame 100 that is excited by operation of the disc brake assembly 220a and/or disc brake assembly 220b (e.g., such a damper 300 is configured to dampen vibrations at a frequency that is within about 50 Hz of the natural frequency of the bicycle frame 100 that is excited by operation of the disc brake assembly 220a and/or disc brake assembly 220b).

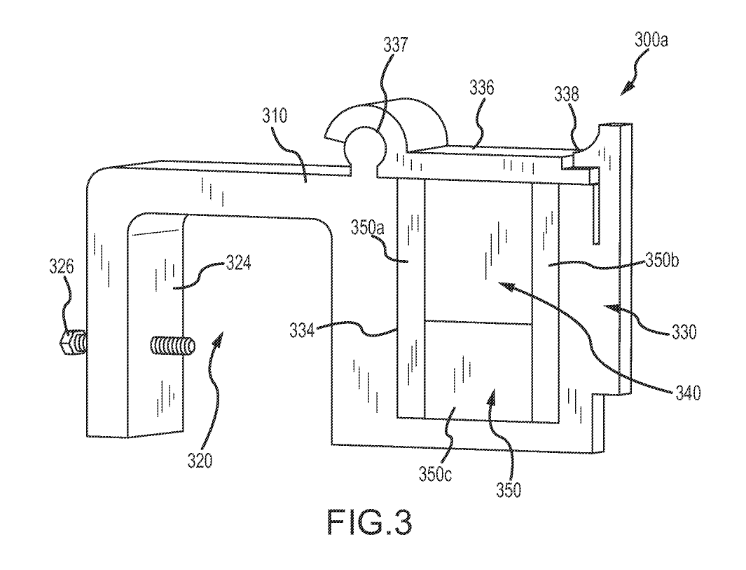

One embodiment of a damper in accordance with the damper 300 is presented in FIG. 3 and is identified by reference numeral 300a. The damper 300a may generally include a damper body 310 that defines a frame engagement portion 320 and a mass engagement portion 330. The frame engagement portion 320 may facilitate attachment of the damper 300a to a frame member of the bicycle frame 100 (e.g., as shown and described above in relation to FIG. 1). For instance, the frame engagement portion 320 may be disposable about at least a portion of the frame member to which it is attached and secured relative thereto in any appropriate manner. For instance and as shown in FIG. 3, the frame engagement portion 320 may include a generally “U” shaped bracket or bicycle frame mount 324 that may be fitted to the frame member to which the damper 300a is attached. The closed end of the bracket 324 may be positioned over an upper portion of the bicycle frame 100 in at least some embodiments (e.g., such that a mass 340 moves at least in a vertical dimension (e.g., orthogonally to the surface on which the bicycle 10 is traveling) during vibration of the bicycle frame 100 at its natural frequency). In any case and in one embodiment, a fastener 326 may be engaged with the bracket 324 to secure the same to the bicycle frame 100. In this regard, the fastener 326 may be threadably engaged with the bracket 324 such that the fastener 326 and the bracket 324 may form a clamping assembly for clamping engagement of the frame member to which the damper 300a is attached. In another embodiment, the bracket 324 may be secured to the frame member by way of other attachment means without limitation including, for example, a zip tie, an adhesive, or some other mechanism for attachment. Furthermore, the frame engagement portion 320 could be formed as an integral portion of the frame member such that the damper 300a is provided, at least in part, integrally with the frame member. In any regard, the frame engagement portion 320 may rigidly engage the damper 300a to the frame member such that vibrations resulting from a driving force acting on the frame member to which the damper 300a is attached may be received at the damper 300a. Accordingly, the damper body 310 may vibrate concurrently with the frame member to which it is attached.

Additionally, the damper 300a may include a mass engagement portion 330. The mass engagement portion 330 may supportably engage a mass 340 such that the mass 340 is allowed to move or deflect with respect to the damper body 310 in at least one degree of freedom. In this regard, the mass engagement portion 330 may include one or more resilient members 350 provided between the mass 340 and the mass engagement portion 330 to facilitate/accommodate deflection of the mass 340 relative to the damper body 310. For instance and as shown, the damper 300a may include resilient members 350a, 350b, and 350c generally provided on three sides of a rectilinearly shaped mass 340 (other shapes may be appropriate). One or more of these resilient members 350a, 350b, and 350c could be separate structures, one or more of the resilient members 350a, 350b, and 350c could simply be different portions of a common structure, or both. It should be appreciated that fewer than three resilient members may be utilized. For instance, resilient members 350a and 350b may be omitted and, for example, replaced with a bushing member as will be described in greater detail below. Furthermore, a resilient member 350 may be provided on four or more sides of the mass 340, although not shown as such in FIG. 3. In one embodiment, the resilient members 350a and 350b are of a common thickness, while the resilient member 350c is of a larger thickness.

As may be appreciated, the mass engagement portion 330 may define an enclosure 334 that may at least partially surround the mass 340. The enclosure 334 may at least partially be defined by a door, cap, or cover 336. The door 336 may be selectively deflectable to free the mass 340 from the enclosure 334. For instance, the door 336 may be attached to the damper body 310 at a hinge 337 and secured by way of a clasp 338. In turn, upon disengagement of the clasp 338, the hinge 337 may allow the door 336 to deflect away from the enclosure 334 such that the mass 340 and/or the resilient members 350a, 350b, and/or 350c may be removed and/or replaced. A “snap-lock” type of connection may be used to secure the door 336 to the damper body 310. For instance, the door 336 could be totally removable from the damper body 310 to provide access to the mass 340 and/or the resilient members 350a, 350b, 350c. The door 336 could also be movably connected with the damper body 310 in any appropriate manner so as to be movable between open and closed positions.

Accordingly and as described above, the damper 300a may be reconfigured with different masses 340 and/or resilient member(s) 350 to vary the preconfigured frequency to be damped by the damper 300a. In turn, the damper 300a may be provided as a kit with a plurality of masses 340 and/or a plurality of resilient members 350. In turn, upon identifying the frame member to which the damper 300a is to be attached, the appropriate weight 340 and/or resilient member(s) 350 may be selected and installed relative to the enclosure 334. In turn, the door 336 may be secured with the clasp 338 to retainably engage the selected mass 340 and resilient member(s) 350. Accordingly, the damper 300a may be selectively configurable from the kit to preconfigure the damper 300a for use with a frame member—to dampen vibrations at the natural frequency of the bicycle frame 100 that is excited by operation of the disc brake assembly 220a and/or disc brake assembly 220b.

In any regard, the resilient member 350 disposed between the mass 340 and the mass engagement portion 320 of the damper body 310 may allow for movement or deflection of the mass 340 relative to the damper body 310. As such, when a force acts on the damper body 310 (e.g., as received from the frame member, which in turn receives the force resulting from actuation of a disc brake assembly), the damper body 310 may undergo movement (e.g., vibration). The movement may correspond to the movement of the frame member to which the damper body 310 is attached. However, the force acting on the mass 340 may also act on the resilient member(s) 350, which may have a spring constant and/or energy dissipation properties. As a result, the mass 340 may move relative to the damper body 310 in a manner that is at least partially out of phase from the movement of the frame member and damper body 310. Accordingly, the mass 340 and the resilient member(s) 350 may be selected such that the properties of the mass 340 and/or resilient member(s) 350 result in the mass 340 vibrating out of phase when the damper 300a is vibrated at a predetermined frequency. In the case where vibrations are induced in a frame member at the natural frequency of the bicycle frame 100 in response to activation of a disc brake assembly 220, the target frequency which the damper 300a is preconfigured to dampen may be the natural frequency of the bicycle frame 100, measured at the frame member to which the damper 300a is to be attached, and that is excited by operation of the disc brake assembly 220a and/or disc brake assembly 220b.

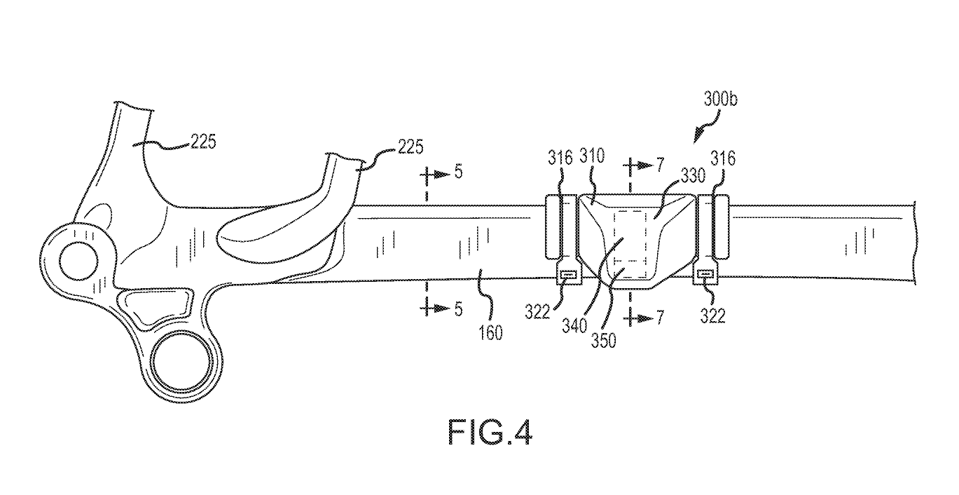

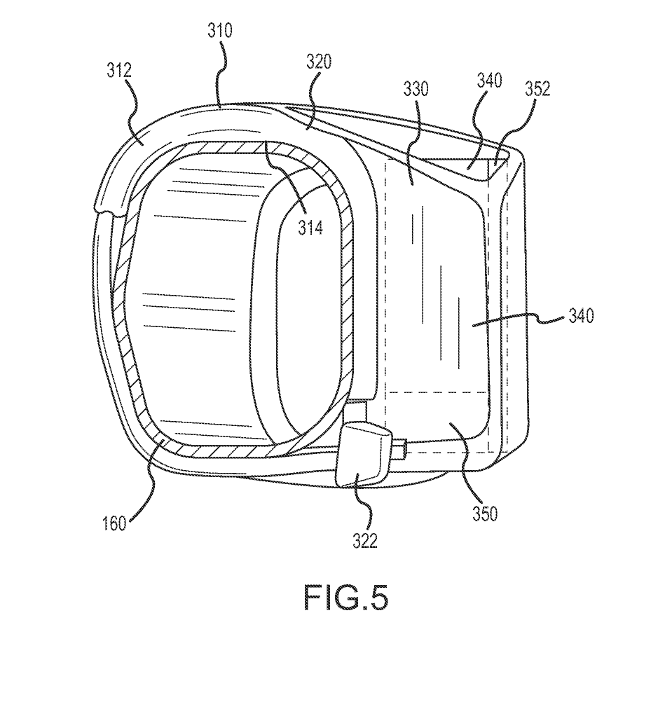

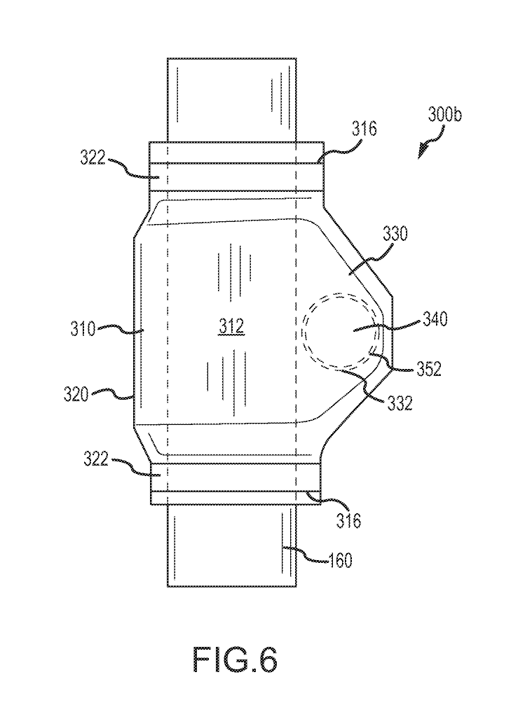

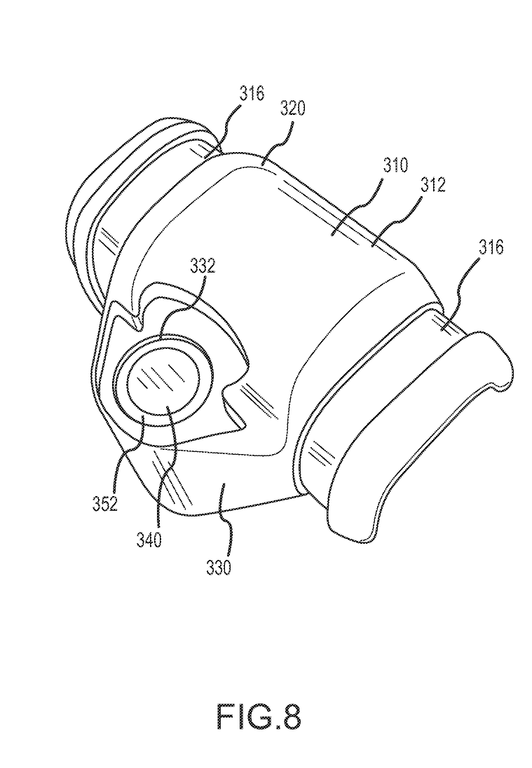

Another embodiment of a damper in accordance with the damper 300 is presented in FIGS. 4-7A and 8 and is identified by reference numeral 300b. The frame engagement portion 320 of the damper 300b shown in FIGS. 4-7A and 8 may include a hood 312 that may conformably engage at least a portion of the frame member (e.g., the chain stay 160 as shown in FIGS. 4-7A) to which the damper 300b is attached. While the embodiment described in FIGS. 4-7A and 8 is discussed as being engaged with a chain stay 160, it may be appreciated that any frame member may be selected for engagement with the damper 300b in an identical manner, and furthermore that the following discussion is not intended to limit the application of the damper 300b disclosed below to use with a chain stay 160. The damper 300b of this embodiment may be installed centrally along the length dimension of the chain stay 160 (e.g., at least generally midway along the length dimension of the chain stay 160). As noted above, the rear disc brake assembly 220b is also mounted to or incorporated by the chain stay 160.

The hood 312 of the damper 300b for the embodiment of FIGS. 4-7A and 8 may extend from the mass engagement portion 330 and at least extend with respect to a portion of the chain stay 160. In this regard, the frame engagement portion 320 including the hood 312 may define a surface 314 that is at least partially correspondingly contoured to at least partially conformably contact the contour of the frame member to which the damper 300b is to be attached. Accordingly, the surface 314 may facilitate at least partial conformal engagement relative to at least a portion of the chain stay 160.

Also shown in FIGS. 4-7A, the damper 300b may be secured to the frame member 160 by way of zip ties 322 that encircle the damper 300b and chain stay 160 to which the damper 300b is attached, to in turn secure the damper 300b to the frame member. In this regard, the frame engagement portion 320 may include grooves 316 sized to receive the zip ties 322 therein. Thus, the grooves 316 may assist in maintaining the zip ties 322 in position relative to the damper 300b such that the potential for the zip ties 322 slipping from the frame engagement portion 310 may be reduced. Any appropriate method of installing the damper 300b on the bicycle frame 100 may be utilized.

In the embodiment of the damper 300b depicted in FIGS. 4-7A and 8, the mass engagement portion 330 may include a receptacle or bore 332 into which the mass 340 is received. In this regard, the bore 332 may at least partially define an enclosure 334 as described above. The bore 332 may be characterized as a “blind hole,” having an open end 333b and an oppositely disposed base or bottom 333a (e.g., a closed end of the bore 332), along with an annular sidewall 335 that extends from the base 333a to the open end 333b. “Annular” means that the sidewall 335 extends a full 360° about a common point or axis, and does not limit the sidewall 335 of the bore 332 to being cylindrical. However, as illustrated by the embodiment of FIGS. 4-7A and 8, the annular sidewall of the bore 332 may in fact be cylindrical.

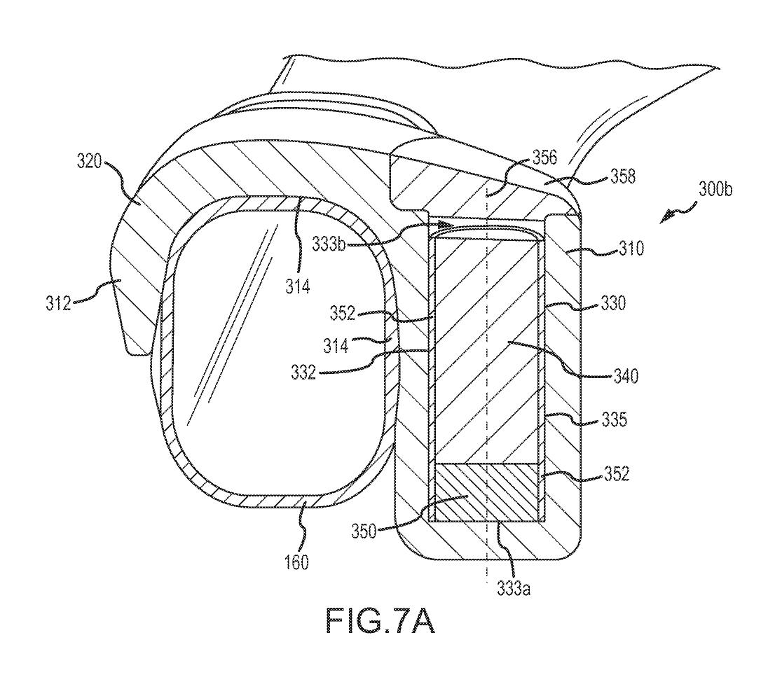

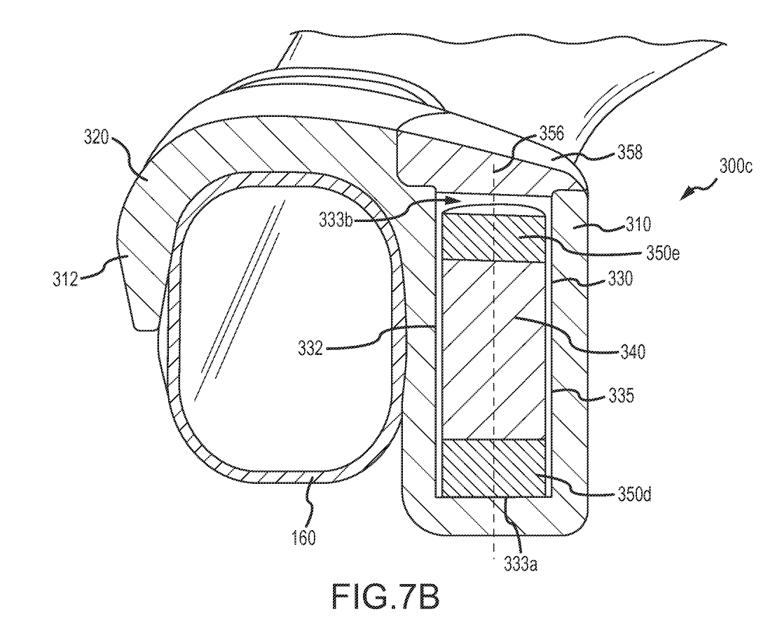

A hollow or tubular bushing 352 may be disposed within the bore 332, and may extend from the base 333a of the bore 332 to its open end 333b. The mass 340 (e.g., a cylindrical mass) may be disposed in the hollow interior of the bushing 352—the bushing 352 is located between the mass 340 and the sidewall 335 of the bore 332 in the illustrated embodiment. In this regard, the bushing 352 may be more rigid than the resilient member 350, and may allow for deflection or movement of the mass 340 along a longitudinal axis 356 of the mass 340. As such, the mass 340 may be movable or deflectable at least in the dimension corresponding to the direction of the longitudinal axis 356 of the mass 340 (e.g., the bushing 352 may be characterized as controlling movement of the mass 340 relative to the damper body 310, for instance to being principally along the longitudinal axis 356). For instance, the bushing 352 may be made from brass or the like and may facilitate displacement of the mass 340 along the axis 356. In this regard, a resilient member 350 may be provided in the bushing 352 so as to be disposed on at least one side of the mass 340 when the mass 340 is disposed in the bushing 352. In the illustrated embodiment, the resilient member 350 is disposed between the mass 340 and the base 333a of the bore 332 (the resilient member 350 being in contact with both the base 333a and the mass 340). It may be possible to eliminate the bushing 352 (e.g., FIG. 7B discussed below). In this case, controlling movement of the mass 340 to principally being along the longitudinal axis 356 may be realized by the spacing between the mass 340 and the inner sidewall 335 of the bore 332 (e.g., using a small spacing).

Accordingly, the deflection of the mass 340 along the dimension corresponding to the longitudinal axis 356 may allow the damper 300b to dampen vibration in a direction corresponding to the dimension in which the mass 340 is deflectable. Accordingly, the damper 300b may be affixed to the frame member to be dampened such that the dimension in which the mass 340 is deflectable corresponds to the dimension in which the amplitude of the vibration of the frame member occurs in response to the operation of a disc brake assembly. In this regard, the vibration may be dampened by the deflection of the mass 340 relative to the damper body 310 and frame member of the bicycle frame 100. It may be appreciated that if the bicycle frame 100 were to vibrate in a number of dimensions in response to operation of a disc brake assembly 220, a damper 300b may be configured to allow the mass 340 to deflect in a corresponding number of dimensions (e.g., by providing resilient members 350 on additional sides of the mass 340 to allow for deflection of the mass 340 in the additional dimensions as needed). Again and in the illustrated embodiment, motion of the mass 340 within the receptacle 332 is at least substantially constrained to a single dimension or along a single axis.

The mass engagement portion 330 may also include an end cap 358 that may provide access to the bore 332 for installation and/or removal of the mass 340 into the bushing 352, for instance to facilitate removal and/or replacement of the mass 340 and/or resilient member 350 as described above. Thus, the mass 340, bushing 352, and/or resilient member 350 may be provided, in at least an embodiment, as a kit for configuration of the damper 300b specifically for engagement with a given frame member of the bicycle frame 100. The end cap 358 could engage the bushing 352 to at least substantially maintain the same in fixed position relative to the mass engagement portion 330. There could also be at least somewhat of a press fit between the bushing 352 and the mass engagement portion 330 of the damper body 310.

A variation of the damper 300b of FIGS. 4-7A and 8 is presented in FIG. 7B. There are two primary differences between these two embodiments. One is that the damper 300c (FIG. 7B) eliminates the bushing 352 that is used by the damper 300b (FIGS. 4-7A and 8)—no structure exists between a perimeter of the mass 340 and the inner sidewall 335 of the receptacle 332. One part of the perimeter of the mass 340 could be in contact with the inner sidewall of the receptacle 332, and an open space could extend from a remainder of the perimeter of the mass 340 to the inner wall 335 of the receptacle 332, or the entirety of the perimeter of the mass 340 could be separated from the inner wall 335 of the receptacle 332 by an open space that extends from the perimeter of the mass 340 to the inner wall 335 of the receptacle 332. Another difference is that instead of using a single resilient member 350, the damper 300c of FIG. 7B has one resilient member 350d on one end of the mass 340, and another resilient member 350e on the opposite end of the mass 340. In the case of the damper 300c of FIG. 7B, motion of the mass 340 within the receptacle 332 is still at least substantially constrained to a single dimension or along a single axis. As such, the resilient members 350d, 350e may be characterized being spaced along an axis along which the mass 340 moves.

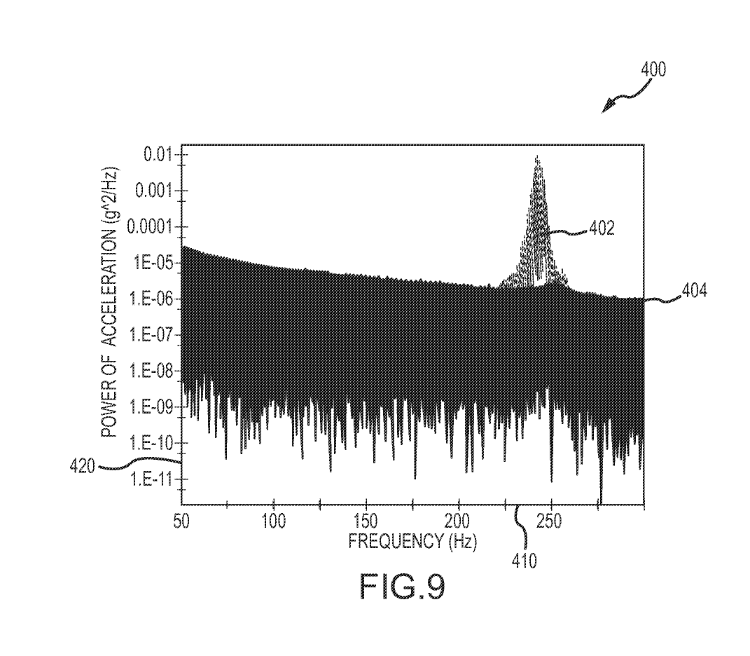

As noted, one or more dampers 300 that are installed one or otherwise incorporated by the bicycle frame may be configured or tuned so as to dampen at least 90% of the amplitude of a vibration in the bicycle frame 100, where this vibration is at a natural frequency of the bicycle frame 100 that is excited by operation of the disc brake assembly 220a and/or disc brake assembly 220b. With further reference to FIG. 9, a graph 400 includes a first plot 402 and a second plot 404. The graph 400 is provided in the frequency domain and shows the power of acceleration represented along the vertical axis 420 in relation to frequency represented along the horizontal axis 410. The first plot 402 corresponds to the vibration of a seat stay 150 for a bicycle without a damper 300 affixed thereto. As may be appreciated from the plot 402, the power of acceleration in the seat stay 150 increases exponentially at a frequency around 240 Hz. Accordingly, it may be appreciated that the bicycle frame 100 may have been excited at the natural frequency during this spike in the power of acceleration in plot 402. That is, the seat stay 150, where the vibration was being measured when the bicycle frame 100 underwent resonance, was vibrating at around 240 Hz. However, for the same seat stay 150 with a damper 300 that is preconfigured to dampen vibrations of the seat stay 150 to counteract vibrations induced at the natural frequency of the bicycle frame 100, the resulting power of acceleration is significantly reduced as reflected in the second plot 404 where the power of acceleration does not spike. As may be appreciated from the graph 400, the natural frequency of the bicycle frame 100, measured at the seat stay 150 used to generate the graph 400, corresponds to about 240 Hz. However and as described above, different frame members may vibrate at different frequencies during resonance of the bicycle frame 100 at the natural frequency of the bicycle frame 100. Accordingly, in an embodiment, the natural frequency of the bicycle frame 100 as measured at the frame member to which the damper 300 is attached, and in turn the frequency targeted by the damper 300, may be at least about 200 Hz and not more than about 320 Hz. For instance, in an embodiment, the natural frequency of the bicycle frame 100 as measured at a given frame member, and in turn the frequency targeted by the damper 300, may be about 260 Hz. In another embodiment, the natural frequency of the bicycle frame 100 as measured at a given frame member, and in turn the frequency targeted by the damper 300, may be about 240 Hz.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A bicycle comprising:
a bicycle frame comprising a frame member;
a wheel that is operatively engaged with and rotatable relative to the bicycle frame;
a disc brake assembly operatively engaged with the bicycle frame and associated with the wheel, wherein operation of the disc brake assembly imparts a driving force to the bicycle frame; and
a damper operatively engaged with the frame member and configured to dampen vibration in the bicycle frame at a natural frequency of the bicycle frame that is induced by operation of the disc brake assembly.

2. The bicycle according to claim 1, wherein the frame member is selected from the group consisting of a seat stay and a chain stay.

3. The bicycle according to claim 1, wherein the damper comprises:
a resilient member; and
a mass engaged by the resilient member, wherein the mass is deflectable relative to the frame member by way of deflection of the resilient member;
wherein the resilient member and the mass are configured so that the mass is deflectable relative to the resilient member out of phase with respect to vibrations of the frame member when the bicycle frame vibrates at a natural frequency of the bicycle frame in response to an imparted driving force resulting from braking the wheel with the disc brake assembly.

4. The bicycle according to claim 3, wherein motion of the mass is constrained to a single dimension.

5. The bicycle according to claim 3, wherein the damper further comprises a damper body comprising:
a frame engagement portion that is separately mounted to the frame member, wherein the frame engagement portion vibrates concurrently with the frame member; and
a mass engagement portion interconnected with the frame engagement portion, wherein the mass and resilient member are each supported by the mass engagement portion.

6. The bicycle according to claim 5, wherein the frame member supportably engages the disc brake assembly that is operable to brake the wheel.

7. The bicycle according to claim 5, wherein the resilient member is disposed between the mass engagement portion and at least two opposing sides of the mass to allow the mass to deflect in at least one dimension relative to the damper body.

8. The bicycle according to claim 7, wherein the at least one dimension corresponds to a dimension of an amplitude of vibration of the frame member in response to the imparted driving force resulting from braking the wheel with the disc brake assembly.

9. The bicycle according to claim 5, wherein the resilient member comprises a first resilient member disposed between a first side of the mass and the mass engagement portion, a second resilient member disposed between a second side of the mass and the mass engagement portion, and a third resilient member disposed between a first end of the mass and the mass engagement portion, wherein the first and second sides of the mass are oppositely disposed, wherein the first end of the mass and a second end of the mass are oppositely disposed, and wherein the second end of the mass is free from contact with the resilient member.

10. The bicycle according to claim 5, wherein the mass engagement portion comprises a receptacle in which the resilient member and mass are disposed.

11. The bicycle according to claim 10, wherein the mass engagement portion at least substantially encloses the entirety of the mass within the receptacle.

12. The bicycle according to claim 10, wherein the damper further comprises a bushing disposed within the receptacle, and wherein the mass is slidably disposed relative to and within the bushing.

13. The bicycle according to claim 12, wherein the resilient member is disposed relative to the mass to allow deflection of the mass along a direction of sliding engagement with the bushing, and wherein the bushing constrains motion of the mass to along a single axis.

14. The bicycle according to claim 12, wherein the receptacle is defined by at least an annular sidewall and a base, wherein the bushing is disposed between the mass and the annular sidewall, and wherein the resilient member is disposed between the mass and the base of the receptacle.

15. The bicycle according to claim 10, wherein the resilient member comprises a first resilient member disposed on one end of the mass and a second resilient member disposed on an opposite end of the mass.

16. The bicycle according to claim 15, wherein the damper lacks a structure between a perimeter wall of the receptacle and a perimeter of the mass, wherein the perimeter of the mass extends between its two ends.

17. The bicycle according to claim 10, wherein the mass engagement portion comprises a cover selectively displaceable relative to the receptacle to provide selective access to the mass.

18. The bicycle according to claim 1, wherein the damper is configured to dampen at least 90% of an amplitude of a vibration at the natural frequency of the bicycle frame, measured at the frame member, that is excited by operation of the disc brake assembly to brake the wheel.

19. The bicycle according to claim 1, wherein the damper is configured to dampen a vibration at a frequency that is within about 50 Hz of the natural frequency of the bicycle frame that is excited by operation of the disc brake assembly to brake the wheel.

20. A method for damping vibrations in a bicycle frame, the method comprising:
braking a wheel of the bicycle with a disc brake assembly, wherein the disc brake assembly is mounted on a first bicycle frame portion of a frame of the bicycle;
imparting a driving force to the first bicycle frame member at a natural frequency of the bicycle frame in response to the braking; and
damping vibration of the bicycle frame at the natural frequency of the bicycle frame with a damper that is associated with the first bicycle frame portion, wherein the damper is tuned to frequency that is within 50 Hz of the natural frequency of the bicycle frame as measured at the first bicycle frame member and that is excited by the braking.
